(19) United States
(12) Patent Application Publication
(10) Pub. No.: US 2020/0114992 A1
(43) Pub. Date: Apr. 16, 2020

(54) TENSION ADJUSTMENT SYSTEM

(71) Applicant: Caterpillar Inc., Deerfield, IL (US)

(72) Inventors: John Edelin, Clayton, NC (US); Dewakar Jonnakuti, Raleigh, NC (US); Ron Maier, Raleigh, NC (US)

(73) Assignee: Caterpillar Inc., Deerfield, IL (US)

(21) Appl. No.: 16/156,644

(22) Filed: Oct. 10, 2018

(51) Int. Cl. B62D 55/30

(52) U.S. Cl. CPC B62D 55/305

(57) ABSTRACT

A tension adjustment system is disclosed. The tension adjustment system may obtain a pressure measurement associated with a tensioning cylinder of a machine; determine a pressure setting associated with the tensioning cylinder; and cause a relief valve and a lubricant pump to enable lubricant, from a lubricant reservoir of the machine, to be added to the tensioning cylinder based on the pressure measurement and the pressure setting, or cause the relief valve and the lubricant pump to enable lubricant in the tensioning cylinder to be released from the tensioning cylinder based on the pressure measurement and the pressure setting.

### TECHNICAL FIELD

The present disclosure relates generally to a tension assembly and, more particularly, to a tension adjustment system.

### BACKGROUND

Tension assemblies and/or recoil assemblies can provide suspension for certain machines and/or tension in tracks for track-type machines. Over time, the tension assembly and/or tracks experience wear, which alters the amount of suspension and/or tension provided by the tension assembly. In such cases, a user may manually adjust the amount of suspension and/or tension provided by the tension assembly by adding lubricant (e.g., grease, oil, and/or any other type of lubricating fluid) to a tensioning cylinder.

One attempt to maintain track tension is disclosed in U.S. Patent Application Publication No. 2006/0196727 to Shields et al. that published on Sep. 7, 2006 (“the Shields application”). In particular, the Shields application discloses a method of using an automatic greasing apparatus for hydraulic track tensioning. The method of the Shields application includes connecting the automatic greasing apparatus to a supply conduit leading to the inlet of the pressure control valve, so that the automatic greasing apparatus is adapted to discharge grease into the supply conduit at periodic intervals without regard to system pressure.

While the automatic greasing apparatus of the Shields application may control hydraulic track tensioning of a track, the Shields application describes using a preset pressure threshold to set the tension and using preset intervals at which the automatic greasing apparatus is to discharge grease without regard to system pressure. Accordingly, the automatic greasing apparatus of the Shields application may not be adaptable to certain conditions of a machine utilizing the automatic greasing apparatus without manual and/or mechanical adjustment of the preset pressure threshold or preset intervals.

The tension adjustment system of the present disclosure solves one or more of the problems set forth above and/or other problems in the art.

### SUMMARY

According to some implementations, the present disclosure is related to a method that includes obtaining a pressure measurement associated with a tensioning cylinder of a machine; determining a pressure setting associated with the tensioning cylinder; and causing a relief valve and a lubricant pump to enable lubricant, from a lubricant reservoir of the machine, to be added to the tensioning cylinder based on the pressure measurement and the pressure setting, or causing the relief valve and the lubricant pump to enable lubricant in the tensioning cylinder to be released from the tensioning cylinder based on the pressure measurement and the pressure setting.

According to some implementations, the present disclosure is related to a device that may include one or more memories and one or more processors, communicatively coupled to the one or more memories, to: determine a track tension setting associated with a track of a machine; and control a relief valve to adjust a pressure of a tensioning cylinder of the track based on the track tension setting, wherein the pressure of the tensioning cylinder is adjusted by setting a relief pressure of the relief valve that controls a flow of lubricant between a lubricant reservoir of the machine and the tensioning cylinder.

According to some implementations, the present disclosure is related to a system that may include a tensioning cylinder; a relief valve; a lubricant reservoir configured to hold lubricant, wherein the lubricant is used to adjust a pressure within the tensioning cylinder based on a setting of the relief valve; a lubricant pump configured to transfer the lubricant between the lubricant reservoir and the tensioning cylinder; a pressure sensor; and an electronic control module to: receive, from the pressure sensor, a pressure measurement associated with the tensioning cylinder; determine a pressure setting associated with the tensioning cylinder; and adjust the setting of the relief valve based on the pressure measurement and the pressure setting.

### BRIEF DESCRIPTION OF THE DRAWINGS

FIG. 1 is diagram of an example machine utilizing an example tension adjustment system in accordance with an example implementation described herein.

FIG. 2 is a diagram of an example tension assembly that may include an example tension adjustment system in accordance with an example implementation described herein.

FIG. 3 is diagram of an example implementation of a tension adjustment system, as described herein.

FIG. 4 is a flow chart of an example process associated with a tension adjustment system, as described herein.

### DETAILED DESCRIPTION

This disclosure relates to a tension adjustment system for a tension assembly. The tension adjustment system has universal applicability to any machine utilizing a tension assembly. The term “machine” may refer to any machine that performs an operation associated with an industry such as, for example, mining, construction, farming, transportation, or any other industry. As some examples, the machine may be a vehicle, a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other above ground equipment, underground equipment, or marine equipment. Moreover, one or more implements may be connected to the machine and driven from the tension adjustment system.

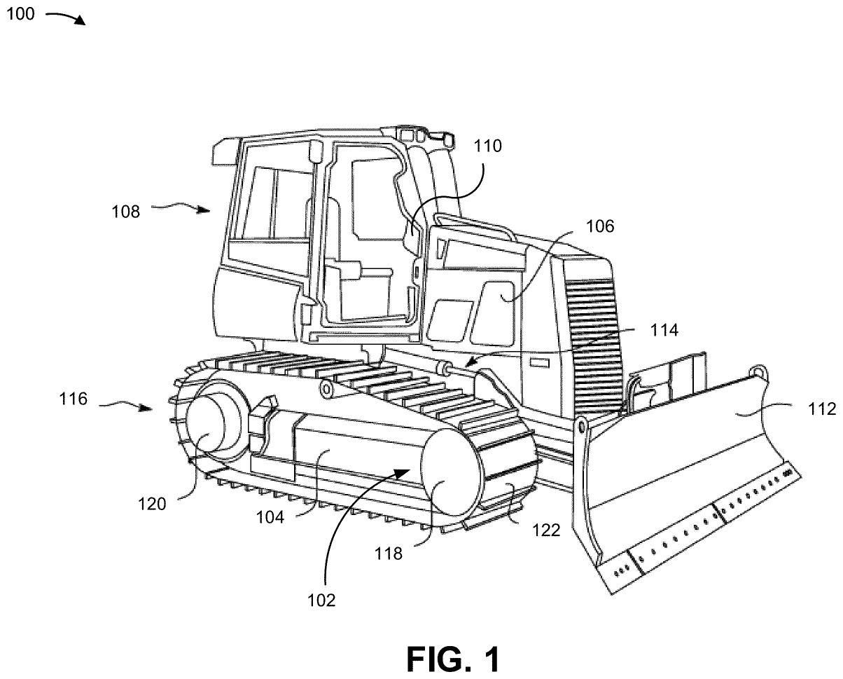

FIG. 1 is a diagram of an example machine 100 utilizing an example tension adjustment system of a tension assembly 102 in accordance with an example implementation described herein. As shown in FIG. 1, machine 100 is a track type tractor, and tension assembly 102 is within a roller frame 104 of machine 100. In some implementations, machine 100 may be any other tracked mobile machine such as, a track loader, an excavator, a dozer, and so on that performs operations associated with industries such as mining, construction, farming, transportation, landscaping, or the like. While some example implementations are described herein in connection with a track-type tractor, such as machine 100, in some implementations, tension assembly 102 and/or a corresponding tension adjustment system, as described herein, may be implemented in other tracked machines and/or other non-tracked machines (e.g., machines that utilize a tension assembly in a suspension system).

Machine 100 includes a power source 106 and an operator's station 108. The operator's station 108 may include one or more user interfaces 110 to operate machine 100 and/or control a tension adjustment system, as described herein. The one or more user interfaces 110 (referred to herein, individually as “user interface 110” and collectively as “user interfaces 110”) may include a control console that includes one or more input devices (e.g., buttons, keypads, touchscreens, trackballs, joy sticks, levers, pedals, steering mechanisms, and/or the like) and/or output devices (e.g., displays, indicators (e.g., illumination indicators), speakers, and/or the like). Machine 100 further includes a machine implement 112 embodied as a blade. Alternatively, the machine implement 112 may include any other work tool such as, a shovel, a ripper, a bucket, and so on for performing a desired task at a worksite. Power source 106 may be an engine (e.g., a diesel engine, a gasoline engine, a gaseous fuel-powered engine, or any other type of combustion engine, and/or the like) that provides power to support, steer, and propel machine 100. In some implementations, power source 106 may provide power to actuate a hydraulic mechanism 114 to move or position the machine implement 112.

Machine 100 further includes an undercarriage system 116. Undercarriage system 116 includes a track system positioned on each of two opposing side frames of machine 100. Undercarriage system 116 includes roller frame 104 coupled with a side frame and a number of rotatable track-engaging elements, such as an idler 118 and a sprocket 120. Idler 118 is configured to rotate passively during operation of undercarriage system 116. Sprocket 120 is configured to drive undercarriage system 116.

Undercarriage system 116 includes a number of track rollers (not shown) mounted to roller frame 104 to bear a weight of machine 100. Undercarriage system 116 further includes a track 122 extending about each of the rotatable track-engaging elements, that is, the idler 118 and the sprocket 120. The embodiment shown in FIG. 1 will be recognized by those skilled in the art as a low drive or an oval track system, however, it should be appreciated that the present disclosure could be applied to high drive tracks or some other track configuration. Also, the design of the tension assembly 102 and/or tension adjustment system shown in the accompanying figures is exemplary and may vary based on the application.

As further described below, machine 100 may utilize a tension adjustment system to adjust a pressure of a tensioning cylinder of tension assembly 102 to increase and/or decrease tension in track 122. In some implementations, the tension adjustment system may adjust the pressure automatically according to one or more operating characteristics of machine 100 (e.g., as determined by sensor devices of machine 100) and/or based on a user input received via user interface 110. Accordingly, an example tension adjustment system, as described herein, may control the track tension of machine 100 during operation of machine 100 (e.g., in real-time and/or on-demand).

As indicated above, FIG. 1 is provided as an example. Other examples are possible and may differ from what was described in connection with FIG. 1.

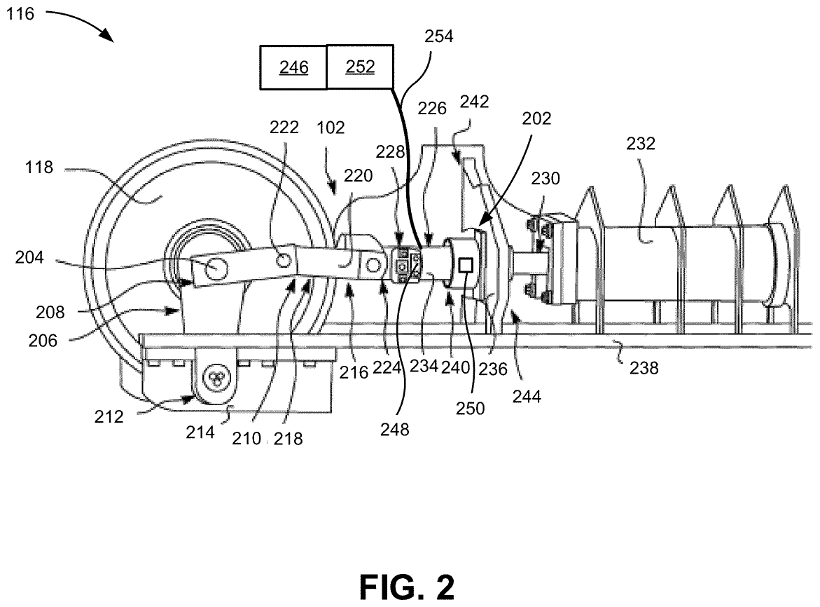

FIG. 2 is a diagram of an example tension assembly 102 that may include an example tension adjustment system 202 in accordance with an example implementation described herein. Referring to FIG. 2, idler 118 has a central opening to receive a mechanical fastener 204 (e.g., a pin, and/or the like). Undercarriage system 116 includes tension assembly 102 capable of absorbing various shocks and other forces which may act on the undercarriage system 116. Tension assembly 102 is configured to provide tension on track 122, as described herein. Tension assembly 102 includes a swing link 206 having a first end 208 and a second end 210.

First end 208 of swing link 206 is coupled to idler 118 such that swing link 206 can rotate about the first end 208. Swing link 206 is connected to idler 118 at the opening in idler 118 through mechanical fastener 204. First end 208 of swing link 206 has a hole to allow mechanical fastener 204 to pass through for coupling swing link 206 to idler 118. Swing link 206 has a third end 212. Idler 118 is mechanically connected to a guard 214 at the third end 212 of swing link 206 in a similar manner as the first end 208 of swing link 206 is connected to idler 118. A similar second swing link (not shown) is provided on an opposite side of idler 118. The second swing link is coupled to idler 118 in a similar manner. Second end 210 of swing link 206 is coupled to a yoke 216. Yoke 216 has a first end 218 having a first arm 220 and a second arm (not shown) extending on either side of idler 118. First arm 220 is coupled with second end 210 of swing link 206 through a pivot joint 222. The second arm may be similarly coupled with the second swing link. Any other type of joint may also be used to couple first arm 220 and the second arm of yoke 216 with swing link 206 and the second swing link. Yoke 216 may rotate about the first end 218 based on the corresponding relative motion of swing link 206.

A second end 224 of yoke 216 is coupled to a tensioning cylinder 226. Tensioning cylinder 226 has a head end 228 and a rod end 230. As illustrated, head end 228 of tensioning cylinder 226 is coupled to second end 224 of yoke 216. Head end 228 of tensioning cylinder 226 includes an eye. Mechanical fasteners (e.g., pins, bolts, and/or the like) may be used to couple second end 224 of yoke 216 with the eye of head end 228 of tensioning cylinder 226. Rod end 230 of tensioning cylinder 226 is connected to a recoil spring 232. Various other parts may be connected in between to facilitate coupling of rod end 230 of tensioning cylinder 226 and the recoil spring 232. It should be contemplated that either of head end 228 of tensioning cylinder 226 or rod end 230 of tensioning cylinder 226 may be coupled to second end 224 of yoke 216 without departing from the scope of the present disclosure.

Tensioning cylinder 226 may be actuated by hydraulic or pneumatic means. An outer surface 234 of tensioning cylinder 226 is machined so as to make outer surface 234 smooth and reduce friction. Outer surface 234 of tensioning cylinder 226 may also be partially machined. In some implementations, outer surface 234 of tensioning cylinder 226 is machined between a length equal to that of travel of tensioning cylinder 226. Tension assembly 102 of FIG. 2 includes a bulkhead 236 having an opening to receive tensioning cylinder 226. As shown, the opening has a circular cross-section. In some implementations, the opening may have any other cross-sectional shape based on a corresponding design or application of tension assembly 102. Bulkhead 236 is supported by a set of rails 238 extending across the undercarriage system 116 supporting various other parts and subsystems not described herein. Bulkhead 236 may also be supported by any other such mechanism in accordance with the scope of the present disclosure.

A guide assembly 240 is attached to bulkhead 236 to support tensioning cylinder 226. Guide assembly 240 has a first end 242 proximate to head end 228 of tensioning cylinder 226 and a second end 244 proximate to rod end 230 of tensioning cylinder 226.

As shown in FIG. 2, the tension adjustment system 202 includes a lubricant reservoir 246, a relief valve 248, a pressure sensor 250, a lubricant pump 252, and one or more lubricant lines 254. The tension adjustment system 202 may be controlled to add lubricant (e.g., grease, oil, and/or any other type of lubricating fluid), from lubricant reservoir 246, to tensioning cylinder 226 to increase a pressure within tensioning cylinder 226. Increasing the pressure within tensioning cylinder 226 may increase a tension of track 122 by applying increased force on yoke 216, which pushes idler 118 into track 122. On the other hand, tension adjustment system 202 may be controlled to release lubricant from tensioning cylinder 226 via relief valve 248 (e.g., based on a setting of relief valve 248) to decrease and/or maintain a pressure within tensioning cylinder 226. Decreasing the pressure within tensioning cylinder may decrease a tension of track 122 by decreasing the force on yoke 216, which draws idler 118 toward tension assembly 102.

Lubricant pump 252 may be controlled to transfer lubricant between lubricant reservoir 246 and tensioning cylinder 226. Lubricant pump 252 may include one or more adjustment cylinders (e.g., one or more hydraulic cylinders) to transfer the lubricant via the lubricant pump. The one or more adjustment cylinders may be configured within lubricant pump 252 to push the lubricant to tensioning cylinder 226 from lubricant reservoir 246 and/or pull the lubricant from tensioning cylinder 226 to lubricant reservoir 246. Additionally, or alternatively, lubricant pump may include a valve (e.g., a cartridge valve) to control the flow of the lubricant to/from tensioning cylinder 226 and/or to/from lubricant reservoir 246.

As shown in FIG. 2, lubricant reservoir 246 and/or lubricant pump 252 may be situated separately from undercarriage system 116. For example, the lubricant reservoir 246 and/or lubricant pump 252 may be mounted to a frame of machine 100. Accordingly, lubricant lines 254 may run between lubricant reservoir 246, lubricant pump 252, and tensioning cylinder 226. In some implementations, relief valve 248 may release lubricant into a lubricant line 254 that returns lubricant to lubricant reservoir 246, creating an enclosed loop.

As indicated above, FIG. 2 is provided as an example. Other examples are possible and may differ from what was described in connection with FIG. 2.

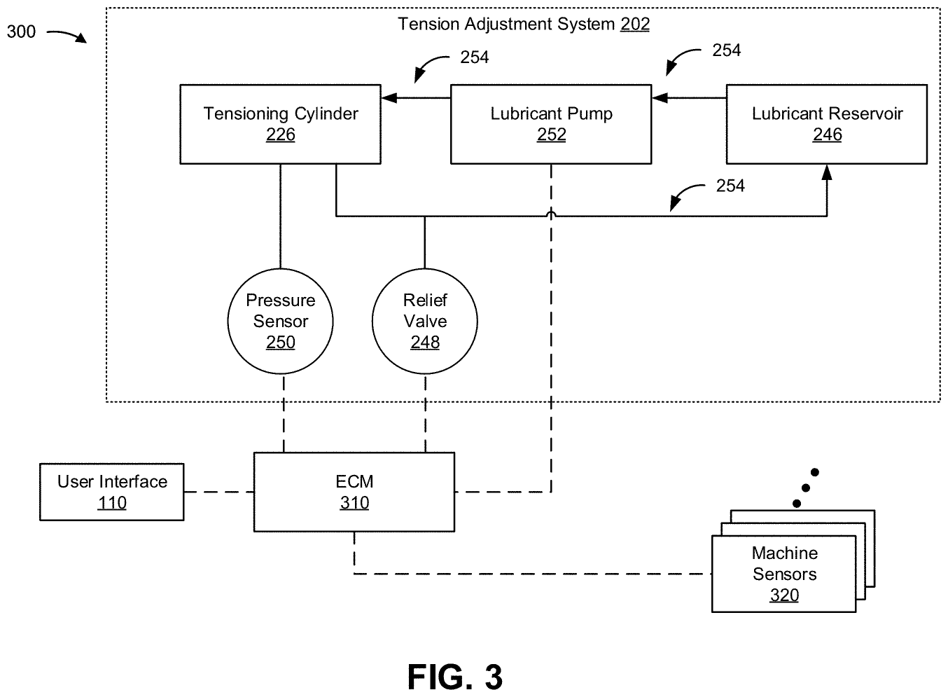

FIG. 3 is a diagram of an example implementation of tension assembly control system 300 to control a tension adjustment system 202, as described herein. As shown in FIG. 3, tension assembly control system 300 may include user interface 110, tension adjustment system 202 (which includes tensioning cylinder 226, lubricant reservoir 246, relief valve 248, pressure sensor 250, lubricant pump 252, lubricant lines 254), an electronic control module (ECM) 310, and machine sensors 320. In FIG. 3, mechanical connections are shown with solid lines while electrical connections are shown as dashed lines. Any electrical connections within tension assembly control system 300 may be wired and/or wireless.

ECM 310, as described herein, provides control of tension adjustment system 202 in order to control pressure in tensioning cylinder 226 and/or control a corresponding track tension of track 122 according to a user input received via user interface 110, one or more measurements received from pressure sensor 250, and/or one or more measurements received from machine sensors 320. ECM 310 is implemented as a processor, such as a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of hardware-implemented processing component. The processor is implemented in hardware, firmware, or a combination of hardware and software. In some implementations, ECM 310 includes one or more processors capable of being programmed to perform a function. In some implementations, one or more memories, including a random-access memory (RAM), a read only memory (ROM), and/or another type of dynamic or static storage device (e.g., a flash memory, a magnetic memory, and/or an optical memory) may store information and/or instructions for use by ECM 310. In some implementations, ECM 310 may include a memory (e.g., a non-transitory computer-readable medium) capable of storing instructions, that when executed, cause the processor to perform one or more processes and/or methods described herein. A computer-readable medium is defined herein as a non-transitory memory device. A memory device includes memory space within a single physical storage device or memory space spread across multiple physical storage devices.

ECM 310 may execute the instructions to perform various control functions and processes to control tension adjustment system 202, and, as such, to automatically control pressure of tensioning cylinder 226 using relief valve 248 (e.g., by adjusting a setting of relief valve 248). ECM 310 may include any appropriate type of engine control system configured to perform engine control functions such that power source 106 may operate properly. ECM 310 may control lubricant pump 252 to control the flow of lubricant between tensioning cylinder 226 and lubricant reservoir 246. Further, ECM 310 may also control other systems of machine 100, such as transmission systems, hydraulics systems, and/or the like.

In operation, computer software instructions may be stored in or loaded to ECM 310. ECM 310 may execute the computer software instructions to perform various control functions and processes to control tension adjustment system 202 and to automatically adjust one or more parameters of tension adjustment system 202, such as a pressure within tensioning cylinder 226 (e.g., via control of lubricant pump 252 and/or relief valve 248), and/or the like. Additionally, or alternatively, ECM 310 may execute computer software instructions to generate and/or cause machine sensors 320 to determine engine temperature values, engine pressure values, engine emission values, engine speed values, actuator or valve position values, engine torque, engine load, drawbar power, and/or other parameter values used to monitor machine 100. Furthermore, in some implementations, ECM 310 may control, include, and/or communicate with one or more systems of machine 100 to determine characteristics of machine 100 or an environment in which machine 100 operates. For example, ECM 310 may obtain location information associated with the machine 100 from a global positioning system (GPS) or other location detection system of machine 100. As another example, ECM 310 may obtain weather information for a location of machine 100 from a remote device or sensor via a communication component of machine 100.

ECM 310 may also identify, obtain, and/or determine parameters that are associated with operating conditions (e.g., as sensed by machine sensors 320) or settings corresponding to the operations of machine 100, such as fuel rate or quantity, engine speed, engine torque, engine load, drawbar power, fuel injection timing, intake manifold temperature (IMAT), intake manifold pressure (IMAP), intake valve actuation (IVA), IVA timing, intake throttle valve position, air injection pressure, fuel injection pressure, torque delivered by power source 106, total fuel injection quantity, exhaust pressure, oxygen/fuel molar ratio, ambient temperature, ambient pressure (e.g., barometric pressure), mass flow through a fuel train of power source 106, exhaust backpressure valve position, coolant temperature, and/or the like.

Machine sensors 320 may include any type of sensor configured to measure one or more parameters associated with machine 100. Machine sensors 320 may be sensors of a sensor system that is communicatively coupled with ECM 310, as described herein. For example, machine sensors 320 may include temperature sensors (e.g., to detect temperature of fuel, air, exhaust, a component, coolant, an ambient temperature of machine 100, and/or the like), position sensors (e.g., to detect a position of a valve, an actuator, an engine part (e.g., a piston), and/or the like), speed sensors (e.g., to detect an engine speed, a machine speed, and/or the like), torque sensors, load sensors, power sensors, pressure sensors, emissions sensors, location sensors, and/or the like.

Pressure sensor 250 may be associated with a sensing parameter that may be used in determining a pressure within tensioning cylinder 226, as described herein. The pressure within tensioning cylinder 226 may depend on an amount of lubricant within tensioning cylinder 226. Accordingly, a value of the sensing parameter for pressure sensor 250 may represent or indicate a pressure measurement of pressure sensor 250. Similarly, other sensor parameters and/or measurements may be received from machine sensors 320, such as a measured pressure (e.g., a fuel pressure, a barometric pressure, and/or the like) of a pressure sensor, a measured temperature of a temperature sensor, a measured speed of an engine (e.g., power source 106) of a speed sensor, a measured position of an actuator or valve by a position sensor, measured emissions by an emissions sensor, and/or the like.

According to some implementations, a position detection system (e.g., a linear variable differential transformer) may be used to determine a position of tensioning cylinder 226. The positioning of tensioning system 226 may depend on the pressure within tensioning system 226 (e.g., as sensed by pressure sensor 250). In some implementations, the position may indicate a displacement of the lubricant within tensioning system 226. Accordingly, tension adjustment system 202 may use position and/or a pressure associated with tensioning cylinder to determine whether lubricant is to be added and/or removed from tensioning cylinder 226, as described herein.

According to some implementations, ECM 310 determines a pressure setting for tensioning cylinder 226. Based on the pressure setting, and a pressure measurement from pressure sensor 250, the ECM 310 may cause lubricant pump 252 to increase an amount of lubricant in tensioning cylinder 226 (e.g., causing a plunger in tensioning cylinder 226 to act or apply force against yoke 216) or decrease an amount of lubricant in tensioning cylinder. Additionally or alternatively, lubricant pump 252 may be configured to continuously transfer lubricant from lubricant reservoir 246 into tensioning cylinder 226 and relief valve 248 may be configured to control the pressure within tensioning cylinder based on a setting of the relief valve 248. The setting of relief valve 248 may correspond to designated pressures at which relief valve 248 is to release lubricant from tensioning cylinder 226, which may then be cycled back to lubricant reservoir 246.

In some implementations, ECM 310 may periodically obtain a pressure measurement from pressure sensor 250. For example, ECM 310 may obtain the pressure measurement according to a predetermined schedule (e.g., every 5 minutes, every 30 minutes, every hour, every 2 hours, and/or the like). In some implementations, ECM 310 may aperiodically obtain the pressure measurement. For example, ECM 310 may obtain a pressure measurement based on a determined and/or detected threshold change (e.g., a 20% change, a 10% change, and/or the like) in the pressure sensed by pressure sensor 250, based on an event, such as a change in operating conditions of machine 100, environmental characteristics (e.g., weather conditions) of machine 100, and/or the like. Accordingly, ECM 310 may monitor the pressure within tensioning cylinder 226 via pressure sensor 250. Pressure sensor 250 may be implemented by any suitable pressure sensor to measure the pressure within and/or associated with tensioning cylinder 226.

In some implementations, the pressure setting may be based on a user input received via user interface 110. For example, a user may specify an amount of pressure for tensioning cylinder 226 to increase or decrease tension on track 122. In some implementations, the amount of pressure may be based on a track tension setting that is received from a user via user interface 110. For example, a user may specify threshold levels of track tension (e.g., low tension, medium tension, high tension, very high tension, and/or the like). ECM 310 may use a mapping of the threshold levels of track tension to pressures at which tensioning cylinder 226 is to be set to achieve those track tensions. Setting the pressure of tensioning cylinder 226 may be achieved by lubricant pump 252 providing lubricant from lubricant reservoir 246 to tensioning cylinder 226 and relief valve 248 being set to release lubricant from tensioning cylinder 226 when pressure within tensioning cylinder 226 reaches the set pressure.

In some implementations, the pressure setting is based on one or more characteristics of machine 100 and/or tension adjustment system 202. For example, ECM 310 may determine the pressure setting for tensioning cylinder 226 based on an operating life of the machine associated with how long or how many hours machine 100 has been in operation, an operating life of components of tension adjustment system (e.g., of tensioning cylinder 226, relief valve 248, pressure sensor 250, lubricant pump 252, lubricant reservoir, and/or the like) associated with how long or how many hours tension adjustment system 202 has been in operation), a location of machine 100, one or more operating conditions of machine 100 (e.g., an engine speed, a track speed, a machine speed, a position (e.g., a pitch, yaw, and/or roll) of machine 100, and/or the like) or one or more environmental characteristics of machine 100 (e.g., ambient temperature, barometric pressure, presence or absence of rain or snow, and/or the like).

According to some implementations, when ECM 310 determines that the pressure associated with tensioning cylinder 226 is not within a threshold range of the pressure setting, ECM 310 may increase the pressure and/or decrease the pressure by adjusting the configuration of relief valve 248 (e.g., by adjusting a setting associated with the pressure at which the lubricant is released from relief valve 248) and/or lubricant pump 252 (e.g., by increasing or decreasing flow through lubricant pump 252). In some implementations, ECM 310 may determine a difference between the pressure setting and the pressure measurement. Based on the difference (e.g., using a mapping of the difference to settings of lubricant pump 252 and/or relief valve 248), ECM 310 may accordingly adjust lubricant pump 252 and/or relief valve 248 to bring the pressure of tensioning cylinder 226 within a threshold range of the pressure setting.

In some implementations, a machine learning model may be used to adjust settings for tension adjustment system 202 (e.g., by adjusting a setting of relief valve 248 and/or lubricant pump 252). For example, the machine learning model may be trained based on one or more parameters associated with machine 100 and/or tension adjustment system 202, such as engine speed, machine speed, track speed, engine torque, engine load, drawbar power, ambient temperature, barometric pressure, location, soil conditions, operating life of machine 100, operating life of track 122, operating life of tension adjustment system 202, pressure as measured by pressure sensor 250, and/or the like. ECM 310 may train the machine learning model using historical data associated with setting relief valve 248 and/or lubricant pump 252 to reach particular pressure settings according to the parameters. Using the historical data and the one or more parameters as inputs to the machine learning model, ECM 310 may set relief valve 248 to release lubricant at a particular measured pressure and/or set lubricant pump 252 to provide lubricant for a particular length of time and/or to provide a particular amount of lubricant to tensioning cylinder 226.

Accordingly, ECM 310 may be configured to control tension adjustment system 202 to increase and/or decrease an amount of track tension of track 122 via adding and/or releasing lubricant from tensioning cylinder 226, as described herein.

The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of tension assembly control system 300 may perform one or more functions described as being performed by another set of devices of tension assembly control system 300.

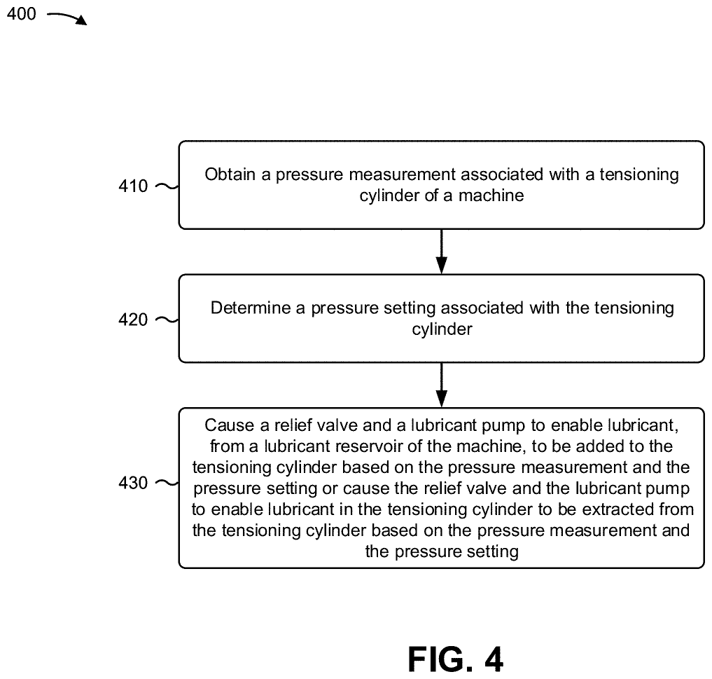

FIG. 4 is a flow chart of an example process 400 associated with a tension adjustment system, as described herein. In some implementations, one or more process blocks of FIG. 4 may be performed by a ECM (e.g., ECM 310). In some implementations, one or more process blocks of FIG. 4 may be performed by another device or a group of devices separate from or including the ECM, such as a user interface (e.g., user interface 110) a pressure sensor (e.g., a pressure sensor 250), and/or machine sensors (e.g. machine sensors 320).

As shown in FIG. 4, process 400 may include obtaining a pressure measurement associated with a tensioning cylinder of a machine (block 410). For example, the ECM may obtain a pressure measurement associated with a tensioning cylinder of a machine, as described above.

As further shown in FIG. 4, process 400 may include determining a pressure setting associated with the tensioning cylinder (block 420). For example, the ECM may determine a pressure setting associated with the tensioning cylinder, as described above.

As further shown in FIG. 4, process 400 may include causing a relief valve and a lubricant pump to enable lubricant, from a lubricant reservoir of the machine, to be added to the tensioning cylinder based on the pressure measurement and the pressure setting or causing the relief valve and the lubricant pump to enable lubricant in the tensioning cylinder to be extracted from the tensioning cylinder based on the pressure measurement and the pressure setting (block 430). For example, the ECM may cause a relief valve and a lubricant pump to enable lubricant, from a lubricant reservoir of the machine, to be added to the tensioning cylinder based on the pressure measurement and the pressure setting or cause the relief valve and the lubricant pump to enable lubricant in the tensioning cylinder to be extracted from the tensioning cylinder based on the pressure measurement and the pressure setting, as described above.

Process 400 may include additional implementations, such as any single implementation or any combination of implementations described below and/or in connection with one or more other processes described elsewhere herein.

In some implementations, the pressure setting is associated with a user input received, by the electronic control module, via a user interface of the machine. In some implementations, the ECM may determine a difference between the pressure measurement and the pressure setting. In some implementations, the ECM may cause the relief valve and the lubricant pump to enable a first amount of lubricant to be added to the tensioning cylinder or cause the relief valve and the lubricant pump to enable a second amount of lubricant to be extracted from the tensioning cylinder. In some implementations, the first amount of lubricant corresponds to the difference between the pressure measurement and the pressure setting when the pressure measurement is less than the pressure setting, and the second amount of lubricant corresponds to the difference between the pressure measurement the pressure setting when the pressure measurement is greater than the pressure setting.

In some implementations, the pressure setting is based on at least one of: an operating life of the machine; an operating life of the tensioning cylinder; a location of the machine; operating conditions of the machine; or an environmental characteristic determined from one or more sensors of the machine. In some implementations, the pressure measurement is obtained according to a time schedule.

In some implementations, the tensioning cylinder is configured to provide track tension for a track of the machine. In some implementations, an amount of the track tension corresponds to a pressure within the tensioning cylinder. In some implementations, the lubricant extracted from the tensioning cylinder is fed back to the lubricant reservoir via a lubricant relief valve.

Additionally, or alternatively a process may include determining a track tension setting associated with a track of a machine. For example, the ECM may determine a track tension setting associated with a track of a machine, as described above.

Such a process may include controlling a relief valve to adjust a pressure of a tensioning cylinder of the track based on the track tension setting. For example, the ECM may control a relief valve to adjust a pressure of a tensioning cylinder of the track based on the track tension setting, as described above. In some implementations, the pressure of the tensioning cylinder is adjusted by setting a relief pressure of the relief valve that controls a flow of lubricant between a lubricant reservoir of the machine and the tensioning cylinder.

Such a process may include additional implementations, such as any single implementation or any combination of implementations described below and/or in connection with one or more other processes described elsewhere herein.

In some implementations, the ECM may determine the pressure of the tensioning cylinder based on the track tension setting using a mapping of possible track tension settings to corresponding pressures of the tensioning cylinder. In some implementations, the mapping is generated based on historical data associated with usage of the machine. In some implementations, the historical data indicates the corresponding pressures of the tensioning cylinder for particular time periods of use of the machine.

In some implementations, the ECM may determine a pressure measurement associated with the tensioning cylinder, compare the pressure measurement and a pressure setting corresponding to the track tension setting, and adjust a pressure release setting of the relief valve based on the pressure measurement and the pressure setting having a threshold difference.

In some implementations, the ECM, when determining the track tension setting, may determine one or more environmental characteristics associated with the machine and determine the track tension setting based on the one or more environmental characteristics.

In some implementations, the track tension setting is received via a user interface of the machine. In some implementations, the ECM may control the relief valve to adjust the pressure of the tensioning cylinder when the pressure of the tensioning cylinder does not satisfy a threshold pressure that corresponds to the track tension setting.

Additionally, or alternatively a process may include receiving, from a pressure sensor, a pressure measurement associated with a tensioning cylinder. For example, the ECM may receive, from a pressure sensor, a pressure measurement associated with a tensioning cylinder, as described above.

Such a process may include determining a pressure setting associated with the tensioning cylinder. For example, the ECM may determine a pressure setting associated with the tensioning cylinder, as described above.

Such a process may include adjusting a setting of a relief valve based on the pressure measurement and the pressure setting. For example, the ECM may adjust the setting of the relief valve based on the pressure measurement and the pressure setting, as described above.

Such a process may include additional implementations, such as any single implementation or any combination of implementations described below and/or in connection with one or more other processes described elsewhere herein.

In some implementations, the lubricant is used to adjust a pressure within the tensioning cylinder based on a setting of the relief valve. In some implementations, the pressure setting is determined based on a track tension setting received via a user interface.

In some implementations, the ECM may determine one or more characteristics associated with the system and determine the pressure setting based on the one or more characteristics. In some implementations, the one or more characteristics include at least one of: a temperature of an environment of the system; a barometric pressure of the environment of the system; a location of the system; or an operating life of the system.

In some implementations, the ECM may determine the pressure setting based on a machine learning model that is trained based on historical data associated with the system and one or more characteristics of the system. In some implementations, lubricant released from the relief valve is returned to the lubricant reservoir. In some implementations, the tensioning cylinder is configured to adjust a tension of a track that is mechanically coupled with an idler. In some implementations, the idler is mechanically coupled with the tensioning cylinder.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

Suspension systems and/or track systems include tension systems and/or recoil systems that are configured to provide suspension and/or track tension for a machine. Over time, the machine may experience wear, causing the suspension to lose pressure and/or the track to lose tension (e.g., due to loosening of the track and/or movement of an idler along a rail). Such wear may lead to poor performance of the machine (e.g., poor grading ability, poor riding experience of a user/operator, and/or the like). Typically, maintaining such systems involves manual, mechanical adjustment to the machine (e.g., repositioning an idler, adding lubricant to the recoil systems, and/or the like).

According to some implementations described herein, the control of tension adjustment system 202, via ECM, enables operators to set and/or adjust track tension for particular conditions and/or according to user preference without needing to manually or mechanically adjust machine 100. For example, a user can select a track tension via an electronic user interface within an operator's station 108 of machine 100. Therefore, the user can adjust a track tension without needing to shut machine 100 down, cease operation of machine 100, or leaving the operator's station 108 to adjust the track tension. This can allow for increased efficiency in operating machine 100, increased productivity while operating machine 100, less downtime associated with operating machine 100, and/or the like.

Furthermore, track tension can be maintained and/or configured regardless of changes in machine 100, track 122 (e.g., due to track 122 stretching over time), and/or regardless of changes in environmental characteristics of machine 100 (e.g., changes in weather, altitude, and/or the like). For example, ECM 310 may be configured to automatically (i.e., without user/operator input) adjust settings of tension adjustment system 202 based on determined characteristics of machine 100, track 122, and/or the environment of machine 100. Accordingly, over time, as parts begin to wear, ECM 310 may automatically adjust the track tension without a user needing to manually adjust the track tension. This can reduce failures associated with track 122 becoming loose (e.g., track 122 breaking, becoming overloaded with material, becoming derailed from rail 238, and/or the like) due to human error (e.g., an operator's failure to increase the track tension). Furthermore, ECM 310 may train a machine learning model to automatically adjust the track according to particular operating characteristics and/or conditions of machine 100. Therefore, ECM 310 may learn and/or identify an optimal track tension (as determined by the machine learning model) to ensure a improved operable lifetime of track 122 and/or machine 100, an increased amount of time between required maintenance, improved performance (e.g., more fuel efficient, more cost efficient, and/or the like).

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations are possible in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of possible implementations. Although each dependent claim listed below may directly depend on only one claim, the disclosure of possible implementations includes each dependent claim in combination with every other claim in the claim set.

What is claimed is:

1. A method, comprising:
obtaining, by an electronic control module, a pressure measurement associated with a tensioning cylinder of a machine;
determining, by the electronic control module, a pressure setting associated with the tensioning cylinder; and
causing, by the electronic control module, a relief valve and a lubricant pump to enable lubricant, from a lubricant reservoir of the machine, to be added to the tensioning cylinder based on the pressure measurement and the pressure setting, or
causing, by the electronic control module, the relief valve and the lubricant pump to enable lubricant in the tensioning cylinder to be extracted from the tensioning cylinder based on the pressure measurement and the pressure setting.

2. The method of claim 1, wherein the pressure setting is associated with a user input received, by the electronic control module, via a user interface of the machine.

3. The method of claim 1, further comprising:
determining a difference between the pressure measurement and the pressure setting; and
causing the relief valve and the lubricant pump to enable a first amount of lubricant to be added to the tensioning cylinder,
wherein the first amount of lubricant corresponds to the difference between the pressure measurement and the pressure setting when the pressure measurement is less than the pressure setting, or
causing the relief valve and the lubricant pump to enable a second amount of lubricant to be extracted from the tensioning cylinder,
wherein the second amount of lubricant corresponds to the difference between the pressure measurement the pressure setting when the pressure measurement is greater than the pressure setting.

4. The method of claim 1, wherein the pressure setting is based on at least one of:
an operating life of the machine;
an operating life of the tensioning cylinder;
a location of the machine;
operating conditions of the machine; or
an environmental characteristic determined from one or more sensors of the machine.

5. The method of claim 1, wherein the pressure measurement is obtained according to a time schedule.

6. The method of claim 1, wherein the tensioning cylinder is configured to provide track tension for a track of the machine,
wherein an amount of the track tension corresponds to a pressure within the tensioning cylinder.

7. The method of claim 1, wherein the lubricant extracted from the tensioning cylinder is fed back to the lubricant reservoir via a lubricant relief valve.

8. A device, comprising:
one or more memories; and
one or more processors, communicatively coupled to the one or more memories, to:
determine a track tension setting associated with a track of a machine; and
control a relief valve to adjust a pressure of a tensioning cylinder of the track based on the track tension setting,
wherein the pressure of the tensioning cylinder is adjusted by setting a relief pressure of the relief valve that controls a flow of lubricant between a lubricant reservoir of the machine and the tensioning cylinder.

9. The device of claim 8, wherein the one or more processors are further to:
determine the pressure of the tensioning cylinder based on the track tension setting using a mapping of possible track tension settings to corresponding pressures of the tensioning cylinder.

10. The device of claim 9, wherein the mapping is generated based on historical data associated with usage of the machine,
wherein the historical data indicates the corresponding pressures of the tensioning cylinder for particular time periods of use of the machine.

11. The device of claim 8, wherein the one or more processors are further to:
determine a pressure measurement associated with the tensioning cylinder;
compare the pressure measurement and a pressure setting corresponding to the track tension setting; and
adjust a pressure release setting of the relief valve based on the pressure measurement and the pressure setting having a threshold difference.

12. The device of claim 8, wherein the one or more processors, when determining the track tension setting, are to:
determine one or more environmental characteristics associated with the machine; and
determine the track tension setting based on the one or more environmental characteristics.

13. The device of claim 8, wherein the track tension setting is received via a user interface of the machine.

14. The device of claim 8, wherein the one or more processors are to:
control the relief valve to adjust the pressure of the tensioning cylinder when the pressure of the tensioning cylinder does not satisfy a threshold pressure that corresponds to the track tension setting.

15. A system comprising:
a tensioning cylinder;
a relief valve;
a lubricant reservoir configured to hold lubricant,
wherein the lubricant is used to adjust a pressure within the tensioning cylinder based on a setting of the relief valve;
a lubricant pump configured to transfer the lubricant between the lubricant reservoir and the tensioning cylinder;
a pressure sensor; and
an electronic control module to:
receive, from the pressure sensor, a pressure measurement associated with the tensioning cylinder;
determine a pressure setting associated with the tensioning cylinder; and
adjust the setting of the relief valve based on the pressure measurement and the pressure setting.

16. The system of claim 15, wherein the system further comprises:
a user interface,
wherein the pressure setting is determined based on a track tension setting received via the user interface.

17. The system of claim 15, wherein the electronic control module is further to:
determine one or more characteristics associated with the system; and
determine the pressure setting based on the one or more characteristics,
wherein the one or more characteristics include at least one of:
a temperature of an environment of the system;
a barometric pressure of the environment of the system;
a location of the system; or
an operating life of the system.

18. The system of claim 15, wherein the electronic control module is further configured to:
determine the pressure setting based on a machine learning model that is trained based on historical data associated with the system and one or more characteristics of the system.

19. The system of claim 15, wherein lubricant released from the relief valve is returned to the lubricant reservoir.

20. The system of claim 15, wherein the system further comprises:
an idler mechanically coupled with the tensioning cylinder,
wherein the tensioning cylinder is configured to adjust a tension of a track that is mechanically coupled with the idler.
